(19) United States
(12) Patent Application Publication
(10) Pub. No.: US 2026/0316352 A1
(43) Pub. Date: Oct. 15, 2026

(54) METHOD OF MANUFACTURING A CLOSURE ELEMENT FOR A CONTAINER AND A CLOSURE ARRANGEMENT

(71) Applicant: Ardagh Metal Packaging Europe GmbH, Zug (CH)

(72) Inventors: Udo Jöbges, Düren (DE); Hajo Rieck, Hennef (DE); Frank Pawella, Meckenheim (DE)

(21) Appl. No.: 19/112,047

(22) PCT Filed: Sep. 14, 2023
(86) PCT No.: PCT/EP2023/075258

§ 371 Date: Mar. 14, 2025

(30) Foreign Application Priority Data
Sep. 14, 2022 (DE) 10 2022 123 526.2

(51) Int. Cl. B29C 45/00; B29C 45/16; B29L 31/56; B65D 17/28

(52) U.S. Cl. CPC B29C 45/0017; B29C 45/0081; B29C 45/1676; B65D 17/4014; B29L 2031/56

(57) ABSTRACT

The invention relates to a method for manufacturing a closure element (1) for a container (2), wherein the closure element (1) comprises at least a first component (3) and a second component (4); wherein the first component (3) can be arranged on the container (2) and the second component (4) is captively connected to the first component (3) at least via a first connection (5), wherein the components (3, 4) are connected to one another rotatably about a first axis of rotation (6) via the first connection (5); wherein the method comprises at least the following steps:
a) providing an injection moulding device (7) with a first mould (8) for one of the components (3, 4);
b) injecting a first material (9) into the first mould (8) and producing one of the components (3, 4);
c) injecting a second material (10) into the first mould (8) and producing the other component (4, 3), thereby producing the first joint (5).

The present invention relates to a method of manufacturing a closure element for a container and a closure arrangement for a container. The container is in particular a beverage container, preferably a beverage container.

The closure arrangement comprises at least one lid element with an opening (and possibly the remaining part of the associated container) as well as a closure element which is non-detachably arranged on the lid element for repeatable, in particular gas-tight, closure of the opening. The lid element is in particular made of metal. The beverage container is used to store a content, e.g. a fluid, whereby the beverage container in the closed state is in particular under excess pressure.

Especially in the case of beverage cans with carbonated contents, the beverage container may be under an internal pressure of up to 6.2 bar before being opened for the first time.

For closing such (beverage) containers, both single-opening and reclosable closure arrangements or closure elements are known. The advantage of reclosable closure arrangements is obvious. Thus, a (beverage) container can be closed, especially gas-tight, even after partial emptying, so that an escape of the fluid stored in the (beverage) container and, especially in the case of carbonated contents, an escape of the carbonation are prevented. The known reclosable closure arrangements or closure elements often have complex components or complex procedures for opening and closing the closure arrangement or closure element.

In particular, a captive arrangement of the closure arrangement on the lid element or on the beverage container is desired, so that all components of the beverage container can be fed into a recycling process.

A resealable closure for a beverage can is known from US 2012/248113A1. A lever, which is supported on the can end, is pivoted and presses a flap into the beverage container. To fix the closure in an open position, the lever must then be arranged at least partially in the beverage container.

From each of DE 10 2016 103 801 A1 and US 2004/0159665A1, a resealable can end for beverage cans is known.

A closure arrangement with a toggle mechanism is known from the republished DE 10 2020 114 863.1.

It is the object of the invention to at least partially solve the problems existing with respect to the prior art and, in particular, to provide a method for manufacturing a closure element by means of which a reproducible product quality can be realised even with a large number of pieces while at the same time making high demands on the precision of the individual parts manufactured. For example, a connection of rotatably interconnected individual parts that is as free of play as possible is to be realised, so that a (gas-tight) sealing of the container is possible even with repeated actuation of the closure element. Furthermore, a closure arrangement for a beverage container is to be provided by means of which the beverage container can be reclosed in a repeatable and, in particular, gas-tight manner. The closure arrangement should have as few individual parts as possible and/or be of low weight, i.e. be producible from as little material as possible. Furthermore, the height of the stacks of closure arrangements should be as low as possible, so that logistics for such closure arrangements can be simplified.

In particular, a closure element of the closure arrangement should be arranged or fastened to the container in such a way that it cannot be lost.

Furthermore, it should also be possible to reseal the container by means of the closure arrangement after it has been opened for the first time, whereby a tightness of the container (with respect to atmospheric pressure) is guaranteed on the one hand at a low pressure in the container and on the other hand even at a pressure inside the container of up to 6.2 bar.

These tasks are solved with a method for manufacturing a closure element according to the features of claim 1 and with a closure arrangement according to the features of claim 12. Further advantageous embodiments of the invention are indicated in the dependent claims. It should be noted that the features listed individually in the dependent claims can be combined with each other in a technologically useful manner and define further embodiments of the invention. In addition, the features set out in the claims are further specified and explained in the description, wherein further preferred embodiments of the invention are illustrated.

A method for manufacturing a closure element for a container, in particular for a beverage container, preferably a beverage can, is proposed.

The closure element comprises at least a first component and a second component, wherein the first component can be arranged on the container and the second component is captively connected to the first component at least via a first connection. The components are rotatably connected to each other about a first axis of rotation via the first connection. The method comprises at least the following steps:
a) providing an injection moulding device with a first mould for one of the components, for example for the first component or for the second component;
b) injecting a first material into the first mould and producing one of the components, e.g. the first component or the second component;
c) injecting a second material into the first mould and producing the other component, thereby producing the first joint.

In particular, the two components are captively connected to each other via the first connection after step c).

In this context, reference is made to DE 33 40 122 C2. There, a method for injection moulding is described, wherein the components successively produced by injection moulding are positively connected via a first connection. In particular, this process is now used to produce the closure element described here.

Thus, a method for manufacturing the closure element is specified by which a reproducible product quality can be realised even with a high number of pieces while at the same time making high demands on the precision of the manufactured individual parts. A largely backlash-free (free of play) connection of rotatably interconnected individual parts can be realised, so that a (gas-tight) sealing of the container is possible even with repeated actuation of the closure element.

With the help of the method, a closure arrangement for a (beverage) container can be provided, by means of which the container can be reclosed in a repeatable and, in particular, gas-tight manner. At the same time, the closure arrangement has as few individual parts as possible and a low weight.

In particular, the materials used are different or the same. This means that a shrinkage dimension can be set or selected in a targeted manner, so that a fit intended for the first connection (clearance fit/press fit/transition fit) can be deliberately realised.

The use of the basically known process for the closure element makes it possible in particular for the filigree and difficult-to-handle (individual) components of the closure element to be joined together or connected to form an arrangement (the closure element) already during injection moulding. Furthermore, damage to the individual components (as a result of the joining) can be prevented in this way, so that series production of large quantities in reproducible quality is also possible.

In particular, the term “first mould” here refers to one component or a plurality of components of the injection moulding devices. The one component is thus produced, for example, in the first mould, i.e. formed by injecting the liquid material into the cavity (the negative of the respective component to be produced) of the first mould. This component can then remain in the first mould or be removed from it and inserted into a further “first mould”.

The cavity required to form the further component can be realised by the first mould (or movable inserts of the first mould) or by the other mould. The first mould can also be formed by a mould half or by a mould insert in which the component remains. This mould half or mould insert can then be supplemented by a further mould half and/or mould inserts to form the cavity of the further component.

The further component is formed by the second material, whereby the cavity is at least partially spatially delimited by the first manufactured component, so that the shape of the subsequently manufactured component is at least partially predetermined by the shape of the first manufactured component. Due to the successive production of the components, they do not join in a form-fitting manner, so that the materials or components are clearly delimited from one another or form mutually contacting interfaces.

The first connection is formed in particular by the first material fully enclosing the second material (or vice versa) at least at one point, in particular along a circumferential direction, e.g. in the form of a shaft-bearing arrangement.

The use of several moulds can accelerate the process, since either a higher number of identical process steps can be carried out simultaneously or the individual process steps can be carried out more quickly one after the other. In particular, the use of several moulds can accelerate the cooling and thus the solidification of the material that has just been injection moulded, so that steps b) and c) can be carried out more quickly one after the other.

In particular, the first connection is formed, at least in one of the components, by a pin element which is produced during injection moulding and has a smallest diameter which is at most three millimetres, preferably at most two millimetres, particularly preferably at most 1 millimetre.

In particular, the first connection is formed at least partially by a cylindrical cross-section and a hollow cylindrical cross-section, which are rotatably connected to each other.

In particular, two spatially separated first connections are produced in step c). In particular, the first axes of rotation of the first connections are arranged coaxially to each other.

As a result of the production of two first connections, components of smaller dimensions can also be produced and stably connected to one another.

In particular, the first component comprises at least one frame part with a window (enclosed by a frame of the frame part) and the second component is a lever (or vice versa). The frame part is arrangeable in an opening of the container. The lever is connected to the frame part via the at least one first connection. The lever can be connected to a cover via a second connection, through which the window and thus the container can be closed in a gas-tight manner. In particular, the lever is connected to the frame part in such a way that the lever is arranged inside the window and can be pivoted about the first connection relative to the frame part.

In particular, the cover is pivotable with the frame part and (at the same time)
positively connected via a second axis of rotation or
materially connected via a hinge.
   hinge.

In particular, the lever is permanently connected to the cover via a guide device forming the second connection, so that the cover can be pivoted, by pivoting the lever about the first axis of rotation, starting from a closed position closing the window in a gas-tight manner, about the second axis of rotation or about the hinge into an open position releasing the window and back again into the closed position.

In particular, the cover is manufactured in step b) or c) together with the frame part as a one-piece (materially joined) component.

In particular, the cover is produced as a further component within the scope of the described process, wherein the cover is injection moulded separately from the first component and the second component in a separate process and thus the form-fitting connection between the cover and the frame part is realised. In this way, the second axis of rotation can be realised in a manner comparable to the first axis of rotation, via which the frame part and the cover are then connected to each other in a pivotable but form-fitting manner.

In particular, after step c), in step d) the cover is arranged in the locked position and the lever is pivoted about the first axis of rotation so that the second connection is formed. In particular, this step d) is carried out automatically, e.g. by a robot or by another manipulation device (but not manually by a person).

In particular, the guide device has at least one guide track arranged on the cover and at least one guide pin engaging in the guide track and arranged on the lever, wherein the at least one guide pin is transferred outside the guide track before step d) and into the guide track during step d). In particular, an elastic deformation of the guide pin or the guide track takes place during step d).

As a result of the elastic deformation or re-deformation, a positive connection between the guideway and the guide pin can be realised. In particular, a ramp or the like can be provided so that the arrangement of the guide pin from outside the guideway into the guideway is simplified or made possible.

In particular, in step d) and after arranging the guide pin in the guideway, when the lever is (further) pivoted about the first axis of rotation, the guide pin is moved along the guideway and the cover is pivoted about the second axis of rotation.

In particular, immediately after removal from the injection moulding device, the closure element has at least the frame part, the cover connected to the frame part and the lever positively connected to the frame part via the first connection. In particular, the at least one guide pin is arranged in the guide path by an automated pivoting of the lever and the closure element is transferred into the closure position (by a further pivoting of the lever relative to the frame part about the first axis of rotation). In particular, this process takes place immediately after removal of the closure element from the first mould.

In particular, the process for manufacturing the closure element is completed after step d).

The above (non-exhaustive) division of the process steps into a) to c) or d) is primarily intended only for differentiation and does not enforce any sequence and/or dependence. It is also possible that process steps at least partially overlap in time. Very preferably, the process steps a) to d) are carried out one after the other and at least steps b) to d) in particular are even carried out offset in time from one another (i.e. not immediately after one another but with a time interval). In particular, steps a) to d) are carried out in the order indicated.

If necessary, a material connection between the lever and the cover, between the lever and the frame part or between the cover and the frame part can be created after step d). This interlocking connection can in particular (exclusively) serve as a freshness seal which indicates whether the closure element has been actuated after the container has been closed for the first time. This material-locking connection is created in particular only after the closure element has been arranged on a lid element of the container. For example, as a result of thermal forming, at least a partial area of the closure element can be formed in such a way that a positive fit is produced between the closure element and the lid element and/or the material connection provided for producing the freshness seal.

The freshness seal serves to indicate the condition of the closure element or the container. An undamaged freshness seal indicates that the closure element has not yet been actuated, i.e. that the container has not been opened. A damaged freshness seal, on the other hand, indicates that the closure element has been actuated at least once, i.e. that the container has been opened at least once.

In particular, a (renewed) pivoting of the lever following step d) is only carried out after the closure element has been arranged on a corner element of a container, namely for (first-time) opening of the container after it has been filled with a fluid.

In particular, then, i.e. for opening a container for the first time or repeatedly, the lever and the cover each rotate in a common direction of rotation about their axes of rotation or about the hinge between a closed position, in which the window is closed by the cover, and an open position, in which the window is released.

In particular, in a step i), a third material is injected into the first mould, which is arranged on a first abutment surface of the first component, preferably the frame part, and forms a sealing material which enables a gas-tight connection between the first component and the container.

In particular, in step i) or in a further step ii), a fourth material is injected into the first mould, which is arranged on a second contact surface of the first component, in particular of the cover, and forms a sealing material which enables a gas-tight connection between the first component, in particular the frame part, and a cover, by means of which the container can be resealed in a gas-tight manner.

Step i) and/or step ii) is/are carried out in particular before step d), preferably before step c), particularly preferably in the context of step b) or c), but in any case after step a).

Steps i) and ii) can be carried out simultaneously or with a time lag.

The third material and the fourth material may be the same or different. In particular, the third and fourth materials are different from the first material and the second material.

If the third material and the fourth material are the same, steps i) and ii) may also be carried out simultaneously, with the material being injected into a continuously connected cavity.

A closure arrangement for a container is further proposed. The closure arrangement comprises at least one lid element of the container having an opening, and a closure member arranged on the lid element for repeatably closing the opening. The lid element has an outer side and an inner side and the opening has an opening edge and an opening plane formed by the opening edge.

The closure element comprises (according to step c)) in particular at least or exclusively a frame part, a lever as well as a cover (possibly also sealing elements). The frame part is arranged at the opening edge of the opening of the lid element and has a window. The lever is (exclusively) connected to the frame part via (and around) a first axis of rotation. The cover closes the window in a closed position of the closure arrangement and is pivotably connected to the frame part via a second axis of rotation or a hinge. The lever is (directly) connected to the cover (and thereby) permanently (i.e. while the closure arrangement is in a state intended for the predetermined operation) via a guiding device, so that the cover can be pivoted, by pivoting the lever about the first axis of rotation, starting from the closure position, about the second axis of rotation or about the hinge into an open position of the closure arrangement releasing the window and back again into the closure position.

The closure element is at least partially, especially completely, producible or manufactured by the described method, wherein the first component comprises at least the frame part and the second component comprises the lever (or vice versa).

In particular, the first axis of rotation and the second axis of rotation or the hinge are arranged parallel to each other and at a distance from each other.

In particular, the frame part and the cover form a sealing surface closing the window in the closed position.

In particular, the closure element enables a repeatable gas-tight closure of the opening.

With an axis of rotation, the components connected thereabove form in particular a shaft and a bearing. The shaft is rotatable relative to the bearing. The components are thus only positively connected to each other, but not materially connected, via the axis of rotation. In the case of the first axis of rotation, the frame part in particular forms the stationary bearing and the lever forms the shaft that can rotate relative to the bearing. In the second axis of rotation, the frame part in particular forms the fixed bearing and the cover forms the shaft that can rotate relative to the bearing.

In the case of a hinge, the components that can be moved relative to each other (in this case, e.g. the cover and the frame part) are permanently connected (in particular by a material bond) by means of an elastically deformable connection. This connection is formed, for example, by a particularly thin section of the components, which is thus elastically deformable. In the case of a hinge, the rotation takes place about the hinge or about an axis of the hinge, but this does not necessarily have to be stationary. In particular, a translatory movement of the components in relation to each other is also possible, whereby this translatory movement can be limited to a minimum by design.

In particular, the lid element is a known lid of a container, e.g. a beverage can, which is connected or connectable to the beverage can. Preferably, the lid element is inseparably (only destructively) connected to the container. In particular, the lid element is made of a metal or a metallic alloy.

The inner side of the lid element forms the side of the lid element facing the contents of the container, whereas the outer side of the lid element forms the side of the lid element facing away from the contents.

The opening of the lid element is in particular at the same time the (only) pouring or removal opening for a content of the container. The shape of the opening is in particular not fixed. In particular, the opening is not rotationally symmetrical. However, a rotationally symmetrical opening can also be closed via the closure element described here and is thus encompassed by the term opening.

A new state of the closure element refers in particular to the state of the closure element produced by the method and arranged on the lid element before a subsequent first actuation, i.e. pivoting, of the lever.

In the new state, all components of the locking arrangement are in the locked position, i.e. the lever is also in a locked position, i.e. in a non-pivoted state. If the lever is in the non-swivelled locking position, the cover is not swivelled either and thus the window or the opening is closed.

In the closed position, the lever is completely on the outside of the lid element. In particular, in the closed position, the frame part and the cover are arranged on both sides of the lid element, i.e. simultaneously on the inside and on the outside, or extend through the opening or the window and/or are accessible from the other side via the opening or the window.

During the pivoting of the lever between the closed position and the open position, the lever passes over the window and over the opening plane at least partially onto the inside of the lid element.

The lever and thus also the cover can be pivoted in particular between the non-pivoted closed position and a pivoted, in particular maximum, open position. In the open position of the closure arrangement, the lever and the cover are each arranged in particular pivoted to the maximum and the window or the opening is preferably opened to the maximum. Between the closed position and the open position, a multitude of (open) positions are possible in which the lever and, if applicable, additionally the cover are arranged in a pivoted position relative to the closed position, but not in the maximum pivoted open position.

In particular, in the closed position, the contents of the beverage container are sealed, especially gas-tight, against the environment of the beverage container, especially against a pressure inside the beverage container of at least 3 bar, preferably at least 5 bar, particularly preferably at least 6.2 bar. In particular, however, a seal is also present if the pressure inside the beverage container corresponds to the pressure of the environment.

In particular, the closure element is made in one piece, i.e. the individual components frame part and lever as well as, if applicable, cover are connected to each other (via the axes of rotation or the hinge, in particular only via the axes of rotation or the hinge) in a non-detachable manner. In particular, these components, especially the frame part and the cover as a jointly manufactured individual component on the one hand and the lever on the other hand, can be manufactured independently of each other and can be connected to each other within the scope of an assembly process. In particular, the frame part and the cover are joined to each other by a hinge and are manufactured together, i.e. in one piece. In particular, the closure element comprises only the components frame part and lever or additionally also the cover. In particular, each of these components is designed to be dimensionally rigid, i.e. non-deformable. The only exceptions are components of the components that are connected to each other in one piece, e.g. via hinges, e.g. the frame part and the cover or the e.g. elastically deformable guide pin.

In particular, only the components frame part, lever and cover of the closure element are involved in the (repeatable) opening or closing of the opening of the lid element.

In particular, the lever and the cover rotate between the closed position and the open position in a common direction of rotation about their axes of rotation or about the first axis of rotation and about the hinge. The lever and the cover there-fore rotate either together in a first direction of rotation or in a second direction of rotation opposite to the first direction of rotation.

In particular, the first rotation axis and the second rotation axis or the hinge are each (substantially) stationary on the closure arrangement.

In particular, the frame part of the closure arrangement is arranged stationary and immovable at the opening edge. The lever and the cover are connected to the lid element via the frame part. The lever and the cover are arranged so that they can move in relation to the frame part.

In particular, the frame part is captively arranged on the opening edge. In particular, the frame part is arranged on the opening edge via a positive connection and can only be detached from the opening edge by destroying the frame part. In particular, the frame part is mounted on the opening edge via a plastic deformation of the frame part. The plastic deformation can be carried out, for example, via a thermal treatment of the frame part, for example, at least local heating.

In particular, the closure element enables a repeatable gas-tight closure of the opening. In particular, the closure element thus enables not only a closure or a liquid-tight closure, but also a gas-tight closure of the opening. This means that, especially in the case of carbonated liquids, the opening can be effectively sealed even after the closure element has been opened for the first time.

In particular, the frame part forms a frame enclosing the opening and thereby forms the window enclosed by the frame. After the frame part has been arranged on the lid element, the opening through which a fluid can flow is thus reduced in particular to the window. The lever is arranged at least in the area of the first axis of rotation within the frame part. During the pivoting of the lever, at least a part of the lever shifts from the outside of the lid element via the window and the opening plane to the inside of the lid element.

In particular, (only) the frame part and the cover form a sealing surface closing the window in the exit position. Thus, the tightness is ensured even in case of repeated opening and closing of the beverage container via the repeatedly stressed sealing surface.

In particular, the guide device has at least one guide track arranged on the cover and at least one guide pin engaging in the guide track and arranged on the lever. When the lever and the cover are pivoted, the guide pin can be moved along the guide track. In particular, the cover has a guide track on each of two opposite sides. In particular, the lever has two guide pins, each guide pin cooperating with a respective guide track.

The guide pin is in particular a, for example, cylindrical or conical extension of the lever, which extends at least partially into the guide track. The guide pin can also be designed as an element rotatably arranged on the lever, e.g. in the manner of a wheel. In particular, the guide pin is arranged stationary on the lever.

In particular, the guide tracks of the cover are arranged between the guide pins of the lever.

The at least one guide track and the at least one guide pin form a positive connection, in particular with respect to both directions of rotation of the lever. Thus, a pivoting of the lever about the first axis of rotation can cause and control a pivoting of the cover about the second axis of rotation or about the hinge.

In particular, the at least one guide pin is arranged in a (self-locking) detent position on the cover in the closed position. Alternatively or additionally, the guide pin forces the cover into a self-locking detent position on the frame part in the closed position. The guide pin only enters the guideway from the detent position when the lever is pivoted about the first axis of rotation, e.g. after exceeding an angular range of pivoting of at least 5 angular degrees, preferably of at least 10 angular degrees, about the first axis of rotation. The cover is then pivoted about the second axis of rotation or about the hinge only after the guide pin has entered the guideway.

In particular, the at least one guideway (preferably both guideways) extends in a direction transverse to the first axis of rotation and the second axis of rotation or the hinge. In the initial position and in a projection of the positions of the axes of rotation or of the hinge and of the at least one guide pin in the opening plane, the first axis of rotation is arranged between the second axis of rotation/the hinge and the guide pin as well as the detent position.

In a maximum pivoted end position of the lever and in a projection of the positions of the pivot axes or the hinge and the at least one guide pin into the opening plane, the guide pin is arranged in particular between the first pivot axis and the second pivot axis/hinge or the second pivot axis/hinge is arranged between the guide pin and the first pivot axis.

The projection takes place in each case in particular along a direction transverse to the opening plane. I.e. the positions of the rotary axes/hinge and the guide pin are viewed from a position e.g. above the opening plane, where the viewing axis is perpendicular to the opening plane.

In particular, for a first position (i.e. e.g. pivoting about the first axis of rotation relative to the closed position) of the cover, the guide device specifies a second position (i.e. e.g. pivoting about the second axis of rotation or about the hinge relative to the closed position) of the cover and vice versa.

In particular, a first seal formed by the third material and surrounding the opening is arranged between the inner side and a first contact surface of the frame part. In particular, the first contact surface is at least partially parallel to a partial surface of the inner side of the lid element. In particular, the first seal is arranged in the area of this partial surface. In particular, the first seal is attached to the frame part and is arranged on this partial surface during assembly of the frame part to the lid element. In particular, the first seal can be produced or is produced together with the frame part within the framework of a two-component injection moulding process, in particular within the framework of step i) or ii).

In particular, a second seal formed by the fourth material and surrounding the window at least in the closed position is arranged between the frame part and the cover. This second seal enables the window or the opening to be sealed by means of a sealing connection between the cover and the frame part. In particular, the second seal is arranged on the frame part or on the cover, preferably on the cover. In particular, the second seal is producible or produced together with the frame part, and possibly also with the cover, within the framework of a two-component injection moulding process, in particular within the framework of step i) or ii).

In particular, the first seal and the second seal are joined to each other by a material bond.

In particular, the frame part and/or the lever and/or the cover and/or the cover is made of a plastic (or of different plastics) with a modulus of elasticity of (in each case) at least 1100 MPa [Megapascal], in particular of at least 1300 MPa, preferably of at least 1600 MPa.

Preferably, the first seal and/or the second seal is made of a plastic with a Shore A hardness of at most 60, in particular at most 45, preferably at most 35.

In particular, the closure element comprises (exclusively) three components, namely frame part, lever and cover (as well as the respective seals connected thereto), wherein these are assembled to form the closure element. In particular, these components are captively connected to each other (via the axes of rotation, in particular only via the axes of rotation).

In particular, the closure element comprises (exclusively) two components (as well as the respective seals connected thereto), wherein the frame part and the cover are manufactured as a materially bonded common injection-moulded component connected via a hinge. The lever is designed as an injection-moulded part that is only positively connected to this component. In particular, these components are captively connected to each other (via the rotary axes/hinge, in particular only via the rotary axes/hinge).

The explanations on the method apply equally to the closure element and the closure arrangement and vice versa.

The use of indefinite articles (“a”, “one”), in particular in the claims and the description reproducing them, is to be understood as such and not as a numeral. Terms or components introduced accordingly are thus to be understood as being present at least once and, in particular, as being present more than once.

As a precaution, it should be noted that the number words used here (“first”, “second”, . . . ) primarily (only) serve to distinguish between several similar objects, variables or processes, i.e. in particular they do not necessarily specify a dependency and/or sequence of these objects, variables or processes in relation to one another. If a dependency and/or sequence is required, this is explicitly stated here or it is obvious to the person skilled in the art when studying the concretely described embodiment. Insofar as a component may occur several times (“at least one”), the description of one of these components may apply equally to all or part of the majority of these components, but this is not mandatory.

The invention and the technical environment are explained in more detail below with reference to the accompanying figures. It should be noted that the invention is not to be limited by the examples of embodiments given. In particular, unless explicitly stated otherwise, it is also possible to extract partial aspects of the facts explained in the figures and to combine them with other facts and findings from the present description. In particular, it should be noted that the figures and especially the proportions shown are only schematic. They show:

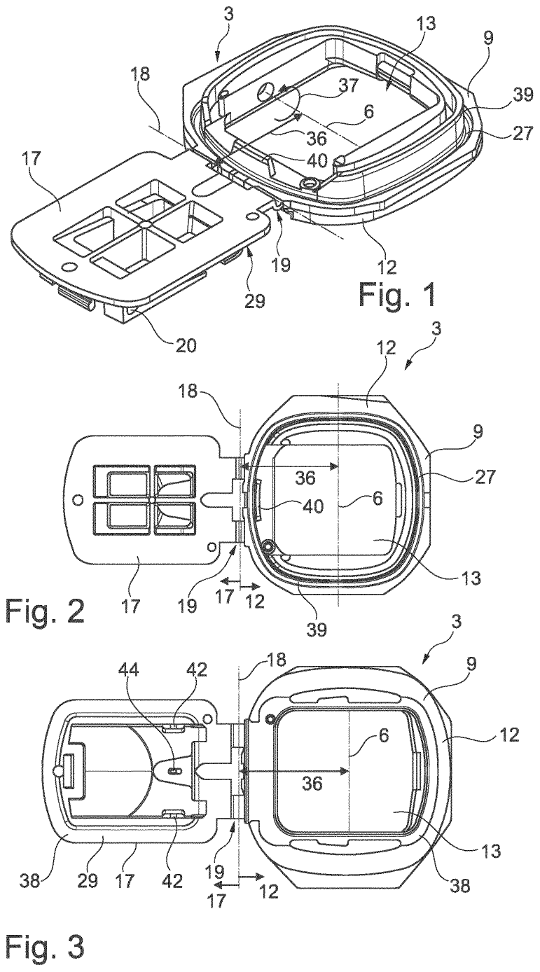

FIG. 1: a frame part with cover in a perspective view;

FIG. 2: the frame part and the cover according to FIG. 1 in a top view from above;

FIG. 3: the frame part and the cover according to FIGS. 1 and 2 in a plan view from below;

FIG. 4: the frame part and the cover according to FIGS. 1 to 3 in a side view;

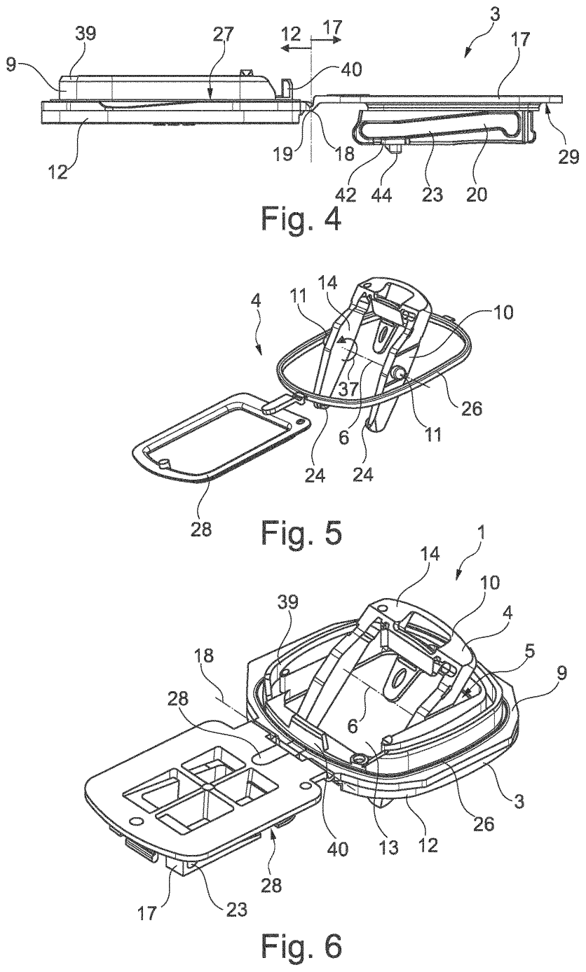

FIG. 5: a lever and sealing materials in a perspective view;

FIG. 6: a closure element in a perspective view;

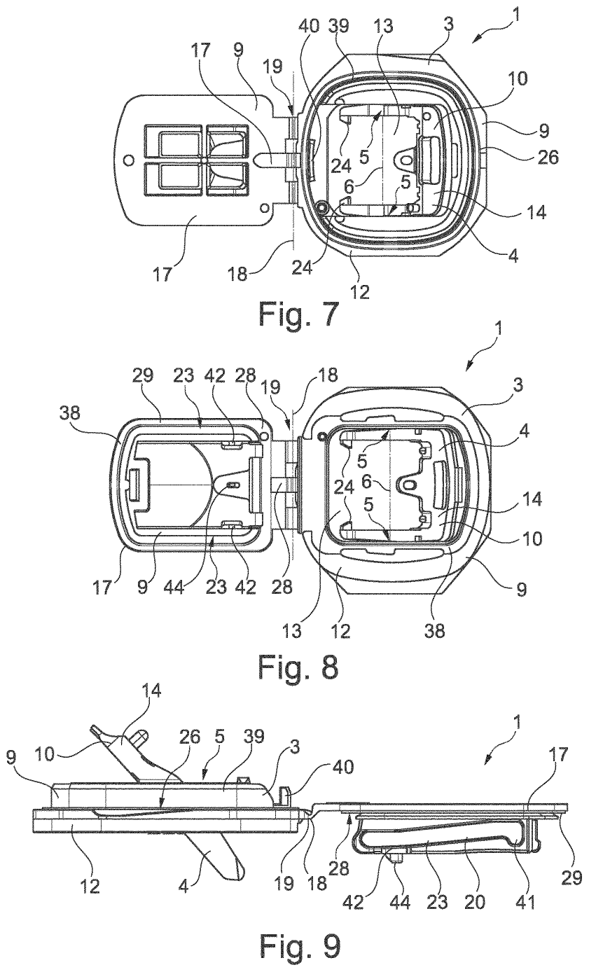

FIG. 7: the closure element according to FIG. 6 in a top view from above;

FIG. 8: the closure element according to FIGS. 6 and 7 in a top view from below;

FIG. 9: the closure element according to FIGS. 6 to 8 in a side view;

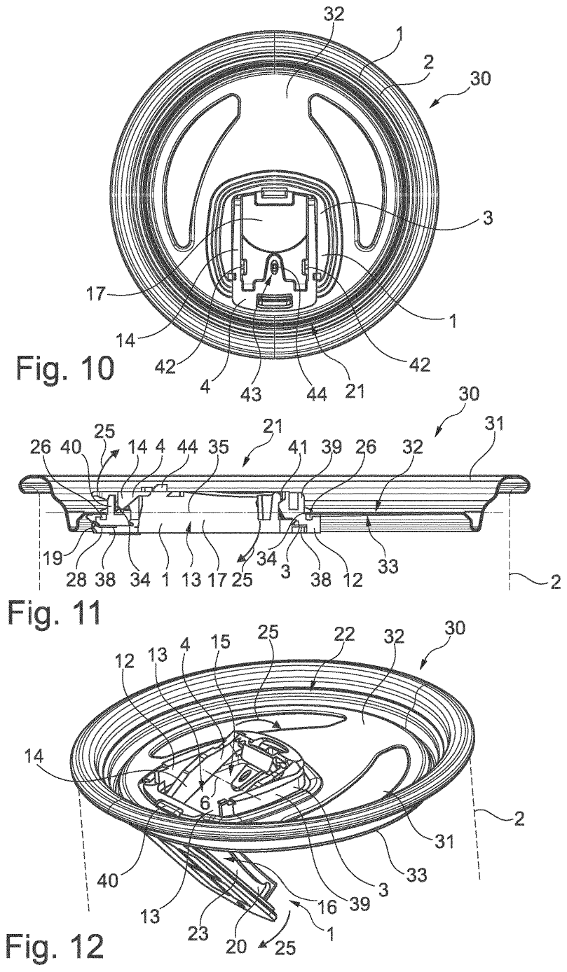

FIG. 10: a closure arrangement in a closure position, in a top view;

FIG. 11: the closure arrangement according to FIG. 10 in a side view in section;

FIG. 12: the closure arrangement according to FIGS. 10 and 11 in an open position, in a perspective view;

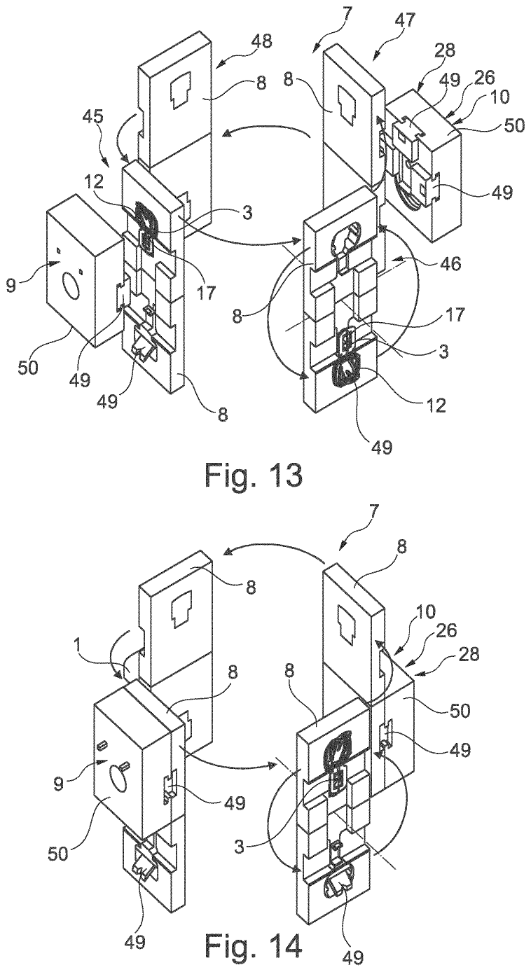

FIG. 13: an injection moulding device with a plurality of first moulds in a perspective view; and

FIG. 14: the injection moulding device according to FIG. 13 in a further perspective view.

FIG. 1 shows a frame part 12 with cover 17 in a perspective view. FIG. 2 shows the frame part 12 and the cover 17 according to FIG. 1 in a top view from above. FIG. 3 shows the frame part 12 and the cover 17 according to FIGS. 1 and 2 in a top view from below. FIG. 4 shows the frame part 12 and the cover 17 according to FIGS. 1 to 3 in a side view. FIGS. 1 to 4 are described together below.

The closure element 1 for a container 2 comprises a first component 3 (here the frame part 12 and the cover 17) and a second component 4 (see FIG. 5: the lever 14 and the sealing materials formed by the third material 26 and the fourth material 28), wherein the first component 3 can be arranged on the container 2 (see FIGS. 10 to 12) and the second component 4 is captively connected to the first component 3 at least via a first connection 5 (see FIG. 6). The components 3, 4 are connected to each other via the first connection 5 so as to be rotatable about a first axis of rotation 6. In step a), an injection moulding device 7 with a first mould 8 for the first component 3 is provided (see FIG. 13). In step b), a first material 9 is injected into the first mould 8 and the first component 3 is produced. In step c), the second material 10, third material 26 and fourth material 28 are injected into the first mould 8 and the second component 4 with the moulded-on sealing materials is produced, the injection already producing the first connection 5.

The first connection 5 is formed by the first material 9 fully enclosing the second material 10 at least at one point, along a circumferential direction 37, i.e. in the form of a shaft-bearing arrangement.

The second component 4 is formed by the second material 10, whereby the cavity is spatially limited by the first component 3 at least in the area of the first connection 5, so that the shape of the subsequently manufactured second component 4 is at least partially predetermined by the shape of the first component 3 manufactured first.

The first component 3 shown in FIGS. 1 to 4 comprises only the frame part 12 and the cover 17, which are connected to each other by a hinge 19. The depicted arrangement of the first component 3 shows the position of the first component 3 in the first mould 8.

FIG. 5 shows a lever 14 and sealing materials in a perspective view. Reference is made to the explanations of FIGS. 1 to 4.

In step c), the second material 10, third material 26 or fourth material 28 is injected into the first mould 8 and the second component 4 is produced with the moulded-on sealing materials, whereby the first connection 5 is already produced by the injection. The illustrated arrangement of the second component 4 and the sealing material shows their position in the first mould 8, whereby the first component 3 has been blanked out.

It can be seen that the sealing material is made in one piece, i.e. that only one material 26, 28 is used to make the sealing material. The lever 14 is arranged pivoted with respect to a closed position 21 (see e.g. FIG. 10), so that there is no undercut in the first mould 8 with respect to the first component 3, except in the area of the first connection 5. The first mould 8 or the movable mould inserts, which serve to create the cavity of the lever 14, can thus extend or be fed through the window 13 of the frame part 12.

Steps i) in which a third material 26 is injected into the first mould 8, which is arranged on a first abutment surface 27 of the frame part 12 and forms a sealing material, and ii) in which a fourth material 28 is injected into the first mould 8, which is arranged on a second abutment surface 29 of the cover 17 and forms a sealing material, are carried out together with step c).

FIG. 6 shows a perspective view of a closure element 1. FIG. 7 shows the closure element 1 according to FIG. 6 in a top view from above. FIG. 8 shows the closure element 1 according to FIGS. 6 and 7 in a top view from below. FIG. 9 shows a side view of the closure element 1 according to FIGS. 6 to 8. FIGS. 6 to 9 are described together below. Reference is made to the explanations of FIGS. 1 to 5.

In step c) the second material 10, third material 26 or fourth material 28 is injected into the first mould 8 and the second component 4 is produced with the moulded-on sealing materials, whereby the first connection 5 is already produced by the injection. The illustrated arrangement of the components 3, 4 and the sealing material shows their position in the first mould 8 after step c).

Here, the third material 26 is arranged on a first contact surface 27 of the frame part 12 and thus enables the (gas-tight) arrangement of the closure element 1 on the lid element 31 (FIG. 11). The fourth material 28 (corresponds here in composition to the third material 26) is arranged on a second contact surface 29 of the cover 17 and enables a gas-tight connection between the frame part 12 and the cover 17, so that the container 2 can be reclosed in a gas-tight manner.

The first connection 5 is formed by cylindrical and diameter pin elements 11 of the lever 14 and correspondingly shaped hollow cylindrical formations in the frame part 12, which are rotatably connected to each other. In step c), two spatially separated first connections 5 are thus produced, the first axes of rotation 6 of the first connections 5 being arranged coaxially with one another.

FIG. 10 shows a closure arrangement 30 in a closure position 21, in a top view. FIG. 11 shows the closure arrangement 30 according to FIG. 10 in a side view in section. FIG. 12 shows the closure arrangement 30 according to FIGS. 10 and 11 in an open position 22, in a perspective view. FIGS. 10 to 12 are described together below. Reference is made to the explanations of FIGS. 1 to 9.

The closure arrangement 30 comprises a lid element 31 of the indicated container 2 with an opening 15 and a closure element 1 arranged on the lid element 31 for repeatably closing the opening. The lid element 31 has an outer side 32 and an inner side 33 and the opening 15 has an opening edge 34 and an opening plane 35 formed by the opening edge 34.

The frame part 12 is arranged at the opening edge 34 of the opening 15 of the lid element 31 and has a window 13. The lever 14 is connected to the frame part 12 exclusively via a first axis of rotation 6 and so as to be pivotable about it. The cover 17 closes the window 13 in a closed position 21 of the locking arrangement 30 and is pivotably connected to the frame part 12 via a second axis of rotation 18 or a hinge 19. The lever 14 is directly connected to the cover 17 and is permanently connected via a guide device 20, so that the cover 17 can be pivoted about the first axis of rotation 6, starting from the closed position 21, about the hinge 19 into an open position 22 of the closure arrangement 30 which releases the window 13 and back again into the closed position 21.

The first axis of rotation 6 and the second axis of rotation 18 or the hinge 19 are arranged parallel to each other and at a distance 36.

The frame part 12 and the cover 17 form a sealing surface 38 closing the window 13 in the closed position 21.

The lever 14 and thus also the cover 17 can be pivoted between the non-pivoted closed position 21 and the, in particular maximum, pivoted open position 22 (see FIG. 12). In the open position 22 of the locking arrangement 30, the lever 14 and the cover 17 are each pivoted to the maximum and the window 13 or the opening 15 is opened to the maximum. The lever 14 and the cover 17 rotate between the closed position 21 and the open position 22 in a common direction of rotation 25 about their axes of rotation 6, 18 or about the first axis of rotation 6 and about the hinge 19.

The frame part 12 is captively arranged on the opening edge 34. The frame part 12 is arranged on the opening edge 34 via a positive connection and can only be detached from the opening edge 34 by destroying the frame part 12 (see FIG. 11). The frame part 12 is mounted on the opening edge 34 via a plastic deformation of the frame part 12. The plastic deformation can be carried out, for example, by means of a thermal treatment of the frame part 12, e.g. at least local heating. In this case, a first element 39 and a second element 40 of the frame part 12 are thermally deformed after the closure element 1 has been arranged on the lid element 31.

The guide device 20 has two guide tracks 23 arranged on the cover 17 and a respective guide pin 24 engaging in the respective guide track 23 and arranged on the lever 14. When the lever 14 and the cover 17 are pivoted, the guide pin 24 can be moved along the guide track 23. The cover 17 has a guide track 23 on each of two opposite sides. The lever 14 has two guide pins 24, each guide pin 24 cooperating with a respective guide track 23.

The guide pin 24 is a cylindrical extension of the lever 14 which extends at least partially into the guide track 23. The guideways 23 and the guide pin 24 form a positive connection with respect to both directions of rotation 25 of the lever 14. Thus, a pivoting of the lever 14 about the first axis of rotation 6 can cause and control a pivoting of the cover 17 about the second axis of rotation 18 or about the hinge 19.

The guide pins 24 are arranged in a self-locking detent position 41 (see FIG. 9) on the cover 17 in the closed position 21. Additionally, in the closed position 21, the guide pins 24 force the cover 17 into a self-locking detent position 41 on the frame member 12 (see FIG. 11).

Between the inner side 33 and a first contact surface 27 of the frame part 12 is arranged a first seal surrounding the opening 15 and formed by the third material 26. The first contact surface 27 of the frame part 12 is oriented at least partially parallel to a partial surface of the inner side of the lid element 31. The opening edge 34 extends into the third material 26 so that it is arranged on the inner side 33 and on the outer side 32 of the lid element 31, unlike shown in FIG. 11. The first seal is attached to the frame part 12 and is arranged on this partial surface as part of an assembly of the frame part 12 to the lid element 31.

Between the frame part 12 and the cover 17, a second seal formed by the fourth material 28 is arranged in the closure position 21 surrounding the window 13. This second seal enables the window 13 or the opening 15 to be sealed by means of a sealing connection between the cover 17 and the frame part 12.

After step c) (see FIG. 9), in a step d) the cover 17 is arranged in the closed position 21, i.e. pivoted into this closed position 21 about the hinge 19, and the lever 14 is pivoted about the first axis of rotation 6, so that the second connection 16 is formed. For this purpose, the guide device 20 has guide tracks 23 arranged on the cover 17 and guide pins 24 engaging in the guide tracks 23 and arranged on the lever 14, the guide pins 24 being transferred outside the guide tracks 23 (see FIG. 9) before step d) and into the guide tracks 23 (see FIG. 12) during step d). In step d), the guide pins 24 are elastically deformed. As a result of the elastic deformation or reshaping, a positive second connection 16 between guide tracks 23 and guide pins 24 can be realised. Ramps 42 (see e.g. FIGS. 8 and 9) are provided on the cover 17 so that the arrangement of the guide pins 24 from outside the guideways 23 into the guideways 23 is simplified or made possible.

In step d) and after the guide pins 23 have been arranged in the guide tracks 24, when the lever 14 is (further) pivoted about the first axis of rotation 6, the guide pins 24 are moved along the guide tracks 23 and the cover 17 is pivoted about the second axis of rotation 18 or about the hinge 19.

After step d), a material connection can be made between the lever 14 and the cover 17. This material-locking connection can serve exclusively as a freshness seal 43, which indicates whether the closure element 1 has been actuated after the container 2 has been closed for the first time. This material-locking connection is only created after the closure element 1 has been arranged on the lid element 31 of the container 2. In the process, a third element 44 of the cover 17 can be heated as a result of a thermal treatment and a material connection with the lever 14 can be created.

FIG. 13 shows an injection moulding device 7 with a plurality of first moulds 8 in a perspective view. FIG. 14 shows the injection moulding device 7 according to FIG. 13 in a further perspective view. FIGS. 13 and 14 are described together below. Reference is made to the explanations of FIGS. 1 to 12.

In this context, reference is made to DE 33 40 122C2. This basically known process is used to manufacture the closure element 1 described here.

Four first moulds 8 are shown here. The four first moulds 8 rotate between individual process steps (first position 45, second position 46, third position 47, fourth position 48) by 90 angular degrees in each case, so that after one rotation of the injection moulding device 7 a further closure element 1 is produced. In FIG. 13 the first moulds 8 are each shown open. In FIG. 14 the first moulds 8 are each shown closed, whereby the respective cavities for the components 3, 4 to be produced are formed by the first moulds 8 in the closed state.

In the first position 45 shown on the bottom left, the cavity for the first component 3 (the frame part 12 together with the cover 17) is formed in the upper part of the first mould 8. Here step b) of the process takes place, as the injection moulding of the first component.

After step b), the injection moulding device 7 rotates so that the first mould 8 is transferred from the first position 45 to the second position 46. This first mould 8 rotates (see arrow) so that in the second position 46 the first component 3 is now arranged in the lower part of the first mould 8.

From the second position 46, the injection moulding device 7 rotates to the third position 47. Here, step c) of the process takes place in the lower part of the first mould 8, i.e. the injection moulding of the second component 4, whereby the first component 3 produced in the first position 45 is already or still arranged in the first mould 8.

After step c), the injection moulding device 7 rotates again so that the first mould 8 is transferred from the third position 47 to the fourth position 48. Here, the removal of the components 3, 4, which are now positively connected via the at least one first connection 6, takes place.

From the fourth position 48, the injection moulding device 7 rotates back to the first position 45. It can be seen that here the upper part of the first mould 8 is now used again to produce the first component 3. As a result of the rotation of the first mould 8 in the second position 46, the injection moulding of each component 3, 4 in the respective same part of the first mould 8 thus only takes place after a rotation of the injection moulding device 7 by 720 angular degrees. In this way, cooling of the first moulds 8 can also be realised in a sufficient manner.

The cavity required to form the components 3, 4 in each case is realised by the first mould 8, which has movable mould inserts 49 and mould halves 50.

### LIST OF REFERENCE SIGNS

1 Closure element
2 container
3 first component
4 second component
5 first connection
6 first rotary axis
7 injection moulding device
8 first mould
9 first material
10 second material
11 pin element
12 frame part
13 window
14 lever
15 opening
16 second connection
17 cover
18 second pivot
19 hinge
20 guide device
21 locking position
22 Opening position
23 Guide track
24 Guide pin
25 direction of rotation
26 third material
27 first contact surface
28 fourth material
29 second contact surface
30 Closure arrangement
31 lid element
32 outer side
33 inner side
34 Opening edge
35 Opening plane
36 Distance
37 Circumferential direction
38 sealing surface
39 first element
40 second element
41 Detent position
42 Ramp
43 Fresh seal
44 third element
45 first position
46 second position
47 third position
48 fourth position
49 mould insert
50 mould half

1. A method for producing a closure element for a container, the method comprising:
providing an injection moulding device with a first mould for a first component;
injecting a first material into said first mould and producing the first component;
injecting a second material into the first mould and producing a second component;
wherein injecting the second material into the first mould produces a first connection between the first component and the second component;
wherein the closure element comprises at least the first component and the second component;
wherein:
the first component is configured to be arranged on the container and the second component is captively connected to the first component at least via the first connection, or
the second component is configured to be arranged on the container and the first component is captively connected to the second component at least via the first connection, and
wherein the first component and the second component are connected to one another rotatably about a first axis of rotation via the first connection.

2. The method of claim 1, wherein the first connection is formed by a pin element during injection moulding, and wherein a smallest diameter of the pin element is at most three millimeters.

3. The method of claim 1, wherein the first component comprises at least one frame part with a window;
wherein the second component is a lever;
wherein the frame part can be arranged in an opening of the container;
wherein the lever is connected to the frame part via the first connection;
wherein the lever can be connected to a cover via a second connection; and
wherein closing the window of the container forms a gas-tight seal.

4. The method of claim 3, wherein the cover is pivotably and positively connected to the frame part via a second axis of rotation or materially connected via a hinge;
wherein the lever is permanently connected to the cover via a guide device forming the second connection, so that the cover, by pivoting the lever about the first axis of rotation, from a closed position which closes the window in a gas-tight manner, about the second axis of rotation or about the hinge into an open position which releases the window and back again into the closed position.

5. The method of claim 4, further comprising, after injecting the second material into the first mould, the cover is arranged in the closed position and the lever is pivoted about the first axis of rotation so that the second connection is formed.

6. The method of claim 5, wherein the guide device comprises at least one guide track arranged on the cover and at least one guide pin arranged on the lever, the at least one guide pin configured to engage in the guide track,
wherein the at least one guide pin is outside the guide track before arranging the cover in the closed position;
wherein the at least one guide pin is transferred into the guide track when arranging the cover in the closed position by elastically deforming at least one of the guide pin or the guide track.

7. The method of claim 6, wherein the closure element comprises the frame part, the cover connected to the frame part, and the lever connected in a form-fitting manner to the frame part via the first connection, and
wherein the closure element is transferred into the closed position by an automated pivoting of the lever and thereby arranging the at least one guide pin in the guide track.

8. The method of claim 6, wherein arranging the cover in the closed position and transferring the at least one guide pin into the guide track also pivots the cover about the second axis of rotation.

9. The method of claim 8, wherein the lever and the cover are configured to rotate between the closed position and the open position, in which the window is released;
wherein opening and closing the window rotates the cover about the second axis of rotation at the hinge.

10. The method of claim 1, further comprising:
injecting a third material into the first mould onto a first contact surface of the first component;
wherein the third material comprises sealing material configured to form gas-tight connection between the first component and the container.

11. The method of claim 10, further comprising:
injecting a fourth material into the first mould onto a second abutment surface of the first component;
wherein the fourth material comprises a sealing material configured to form a gas-tight connection between the first component and a cover,
wherein the gas-tight connection between the first component and the cover allows the container to be resealed in a gas-tight manner.

12. A closure arrangement for a container comprising:
a lid element with an opening, and
a closure element arranged on the lid element, the closure element configured repeatedly close the opening;
wherein the lid element comprises an outer side and an inner side
wherein the opening comprises an opening edge and an opening plane formed by the opening edge;
wherein the closure element comprises at least one frame part, a lever, and a cover;
wherein the frame part comprises a window and is arranged on the opening edge;
wherein the lever is configured to pivotably connect to the frame part via a first axis of rotation; and
wherein the cover closes the window in a closed position of the closure arrangement and is pivotably connected to the frame part via a second axis of rotation at a hinge;
wherein the lever is permanently connected to the cover via a guide device such that pivoting the lever about the first axis of rotation when the cover is closed pivots the cover about the second axis of rotation into an open position;
wherein opening the cover releases the window;
wherein the closure element is at least partially produced by the process according to claim 1; and
wherein the first component comprises at least the frame part and the second component comprises the lever.

13. The closure arrangement of claim 12, wherein the first axis of rotation and the second axis of rotation are arranged parallel to each other and at a distance from each other.

14. The closure arrangement of claim 12, wherein the frame part and the cover form a seal when the cover is in the closed position.

15. The closure arrangement of claim 12, wherein the closure element enables repeatable gas-tight closure of the opening.
